(19) United States
(12) Patent Application Publication
(10) Pub. No.: US 2001/0026532 A1
(43) Pub. Date: Oct. 4, 2001

(54) Optical servo magnetic head

(75) Inventors: Motoji Egawa, Iwata-gun (JP); Shigeyuki Oishi, Iwata-gun (JP)

Correspondence Address: OLIFF & BERRIDGE, PLC, 277 S. WASHINGTON STREET, SUITE 500, ALEXANDRIA, VA, 22314, US

(73) Assignee: MINEBEA CO., LTD.

(21) Appl. No.: 09/824,057

(22) Filed: Apr. 3, 2001

(30) Foreign Application Priority Data
Apr. 4, 2000 (JP) 2000-102278

(51) Int. Cl. G11B 11/00; G11B 7/00; G11B 15/64; G11B 17/32

(52) U.S. Cl. 369/300; 369/13

(57) ABSTRACT

An optical servo magnetic head in which the rigidity in a slider is maintained, and a servo error due to dust particles is suppressed. In a separate type magnetic head (1) generally composed of a slider (2) and a back yoke (3), the slider (2) is provided with magnetic cores (11 and 12) for standard recording density and high recording density, respectively, in order to cover, with a single unit of magnetic head, a plurality of recording media having respective recording densities different from each other. A laser beam is used to guide the magnetic head to a prescribed track position, and passage-holes (5 and 6) for permitting the laser beam to pass through are formed through the slider (2) and the back yoke (3), respectively, by molding or machining. Since the passage-holes (5 and 6) can be respectively set to a minimal size required for permitting the laser beam to pass through, it is possible to maintain rigidity in the slider (2) and prevent fine dust particles generated due to the sliding between the recording medium and a sliding surface of the magnetic head from falling through the passage-holes.

### BACKGROUND OF THE INVENTION

1. Field of the Invention

The present invention relates to a magnetic head used in an optical servo high recording density floppy disk drive (high density FDD), etc., and in particular, to a passage-hole through which a laser beam used to position the magnetic head travels back and forth.

2. Description of the Related Art

As a method of controlling the position of a magnetic head in a floppy disk drive (FDD), an FDD of 1 MB/2 MB type generally adopts an open loop control using a stepping motor.

In case of a high recording density FDD of tens of MB type, the stepping motor is required to have high control accuracy in order to be equal to track density thereof, thereby suffering a cost increase in manufacturing. In case of a still higher recording density FDD (such as 100 or more MB type), still higher control accuracy is required, and a control method using a servomechanism by a laser beam and a voice coil motor has been employed.

More specifically, the control method employed is that a laser beam is emitted from a bottom side of a magnetic head, reflected on a mirror, etc. and shed onto a recording medium disposed on the magnetic head, then the beam returning is sensed whereby the magnetic head is guided to a prescribed track position. FIG. 4 shows an example of a magnetic head used in this control method. The magnetic head 30 shown in the drawing has two magnetic cores 31 and 32 having respective recording densities different from each other. The magnetic cores 31 and 32 form respective independent closed magnetic circuits. The magnetic cores 31 and 32 are provided with respective windings 33 and 34, and inserted into slits 37 and 38 formed in a slider 35. An aperture 36 for permitting a laser beam to pass through is formed in a side face of the slider 35 into which the magnetic cores 31 and 32 are inserted. The aperture 36 is formed in a U-shape extending from the side face up to the central portion of the slider 35. Although not illustrated, the aperture is formed also in a mount block that supports the lower portion of the slider 35.

Japanese Patent Application Laid-open No. Hei 10-177704 discloses that a hole for permitting a laser beam for optical servo to pass through is formed by means of a protrusion provided on a molding die simultaneously when molding, or formed by a mechanical processing after a magnetic head is sealed with resin.

Besides, since the laser beam passing through the aperture 36 is condensed as propagating from the lower (or the bottom) side of the magnetic head 30 to the upper side thereof, that is, toward a recording medium (see FIG. 5A or FIG. 5B), the diameter of the laser beam passing through the lower portion of the magnetic head 30 differs from that passing through the upper portion thereof in such a manner as to decrease as it gets closer to the upper portion. For this reason, the size of the aperture 36 for permitting the laser beam to pass through at the upper portion of the slider 35 is adapted to differ from that at the lower portions thereof in such a manner as to become smaller as it gets closer to the upper portion, i.e. the recording medium. However, in the conventional magnetic head 30, for the convenience of forming, the aperture 36 is sized identical all the way from the lower portion through the upper portion of the slider 35. Accordingly, the aperture 36 is sized unnecessarily larger than required for permitting the laser beam to pass through as it gets closer to the upper portion of the slider 35. In particular, in the longitudinal direction (in the direction in which the aperture 36 is formed extending from the side face toward the central portion of the slider 35) the aperture 36 is sized too far larger than required all the way from the lower portion of the slider 35 through the upper portion thereof, and is even not required at all in the vicinity of the side face where the laser beam does not pass. The aperture 36 formed unnecessarily too large lowers the rigidity in the slider 35, and there arises a problem that the flatness of its sliding surface sliding on the recording medium is distorted due to pressure applied when the magnetic head is processed or assembled. Since the aperture 36 is formed in the slider 35 and the mount block that supports the slider, fine dust particles generated due to sliding between the recording medium and the sliding surface fall through the aperture 36 formed in the slider 35 and the aperture in the mount block and sit on a reflecting mirror or a prism disposed in the laser beam path, resulting in lowered illuminance of the laser beam, thereby creating a factor to cause a servo error. From the above, it is desired that the aperture 36 formed in the slider 35 or the like be as small as possible.

The magnetic head disclosed in Japanese Patent Application Laid-open No. Hei 10-177704 does not employ a so-called separate arrangement in which a slider having a magnetic core and a back yoke holding the slider are provided separately. Further, a passage-hole for permitting a laser beam to pass through is adapted to have a uniform diameter. That is, the passage-hole is not dimensioned differently from portion to portion to a size required for passing the laser beam.

### SUMMARY OF THE INVENTION

The present invention has been made in view of the above-mentioned problems, and an object of the present invention is therefore to provide an optical servo magnetic head, where a laser beam passage-hole can be formed with a minimum size required, thereby maintaining rigidity in a slider for prevention of deformation of a sliding surface, as well as prohibiting fine dust particles from causing a servo error.

To achieve the object described above, according to a first aspect of the present invention, in an optical servo magnetic head comprising: a slider which slides on a magnetic recording medium; magnetic cores which fit in respective openings formed in the slider, are sealed up therein and have respective gaps different from each other to enable the magnetic head to work both for a standard recording density floppy disk drive and a high recording density floppy disk drive; a back yoke which forms closed magnetic circuits in association with the magnetic cores and holds the slider; and a track servomechanism which works using a laser beam; a laser beam passage-hole is formed through the slider and the back yoke, respectively.

To achieve the object described above, according to a second aspect of the present invention, in the optical servo magnetic head of the first aspect of the invention, the laser beam passage-hole is dimensioned in such a manner as to be smaller at the slider side than at the back yoke side.

Using a separate type magnetic head having a slider and a back yoke separately, passage-holes which each have a minimum size required for permitting a laser beam to pass through are formed through the slider and the back yoke, respectively. Since the size of each passage-hole can be set to a minimum required, it is possible to suppress an adverse effect which may occur due to lowering of the rigidity in the slider and the back yoke.

### BRIEF DESCRIPTION OF THE DRAWINGS

In the accompanying drawings:

FIG. 1 is an exploded perspective view showing an embodiment of an optical servo magnetic head according to the present invention;

FIG. 2 is a perspective view showing the optical servo magnetic head shown in FIG. 1 in assembly;

FIG. 3 is a sectional view along the line E-E of FIG. 2;

FIG. 4 is a perspective view showing a conventional magnetic head with a aperture permitting a laser beam to pass through; and

FIGS. 5A and 5B are schematic views showing an example of an optical path of a laser beam and another example thereof, respectively.

### DETAILED DESCRIPTION OF THE PREFERRED EMBODIMENT

An embodiment of an optical servo magnetic head according to the present invention will be described hereafter with reference to the accompanying drawings.

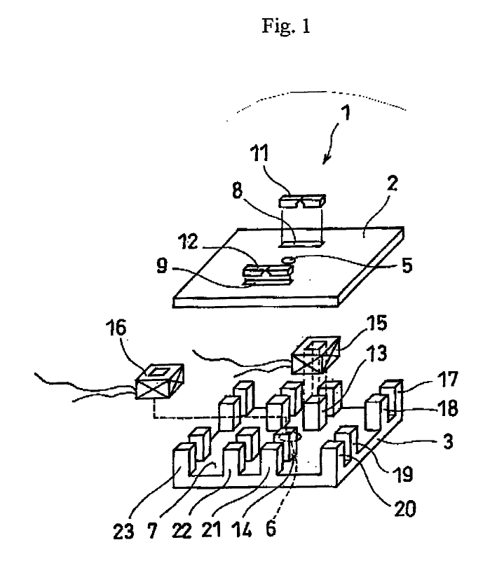

FIG. 1 is an exploded perspective view showing the embodiment of the optical servo magnetic head according to the present invention.

As illustrated in the figure, a magnetic head 1 is generally composed of a slider 2 and a back yoke 3. The slider 2 is provided with magnetic cores 11 and 12 to cover two recording media having respective recording densities different from each other. The back yoke 3 serves to form closed magnetic circuits in association with the magnetic cores 11 and 12, and holds the slider 2. Passage-holes 5 and 6 through which a laser beam used to control the position of the magnetic head 1 passes are formed through the slider 2 and the back yoke 3, respectively. Note that the magnetic head 1 is a so-called separate type in which the slider 2 and the back yoke 3 separated from each other are assembled together as a unit.

Of surfaces of the slider 2, a surface sliding on a recording medium (not shown), i.e. the upper surface in FIG. 1, is formed with two substantially rectangular openings 8 and 9. The magnetic cores 11 and 12 having respective gaps different from each other are inserted into the openings 8 and 9, respectively, and sealed up with a sealer such as glass. The thickness of each of the magnetic cores 11 and 12 is smaller than the thickness (about 0.3 mm) of the slider 2 into which the cores are inserted. Accordingly, these cores 11 and 12 do not protrude from the surface of the slider 2 once the cores 11 and 12 are sealed up in the openings, so there is no fear that the cores are damaged during manufacturing process or transport. One of these magnetic cores 11 and 12 is used for a standard recording density floppy disk drive (FDD), and the other is used for a high recording density floppy disk drive (high density FDD). Each of these cores 11 and 12 has a prescribed gap to serve as a magnetic head. With this arrangement, a single unit of magnetic head 1 can fulfill a read/write operation to cover two recording media having respective capacities different from each other.

The back yoke 3 is provided with a plurality of pillars 13, 14, 17, 18, etc. on a surface 7 that faces the slider 2 when it is assembled into the magnetic head 1. These pillars 13, 14, 17, 18, etc. are integrally formed with the back yoke 3. Read/write coils 15 and 16 for an FDD or a high density FDD are provided on inner pillars 13, 14 of these pillars (pillars 17-23, etc. are referred to as outer pillars). Two lead wires, i.e. a starting end and a finishing end, of each of the read/write coils 15 and 16 are let separately through respective cut-outs present at both sides of one outer pillar. Therefore, a wiring error during manufacture can be eliminated. The outer pillars 17, 18, 19, 20, etc. also serve to magnetically shield the coils 15 and 16 from the outside when the magnetic head is activated. The back yoke 3 and the slider 2 are put together in such a manner that the back yoke 3 hold the slider 2 with the plurality of outer pillars, where the magnetic cores 11 and 12 form respective closed magnetic circuits. Since the magnetic core (magnetic head) for an FDD and the magnetic core (magnetic head) for a high density FDD are not to be operated concurrently, it does not happen that the magnetic flux of one core has an adverse effect on that of the other core.

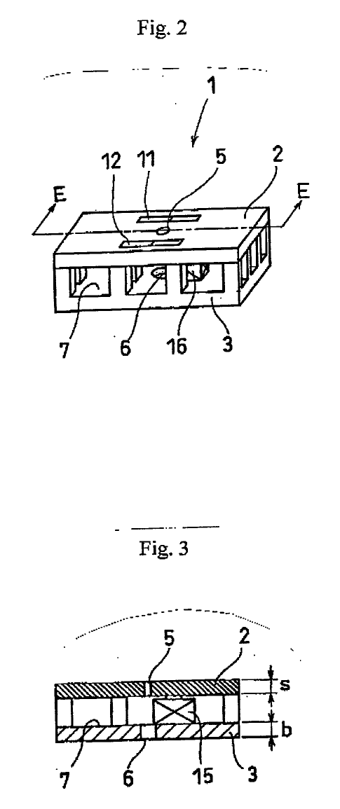

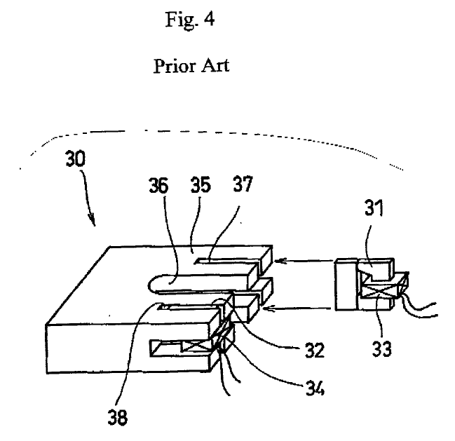

FIG. 2 shows the magnetic head 1 assembled (the slider 2 and the back yoke 3 are put together). The optical servo magnetic head of the present invention has a track servomechanism using a laser beam to guide the magnetic head to a prescribed track position. The mechanism works in such a way that a laser beam is shed onto the recording medium sliding against the sliding surface of the magnetic head and reflected thereat and that the reflected beam is detected thereby controlling the position of the magnetic head relative to the recording medium.

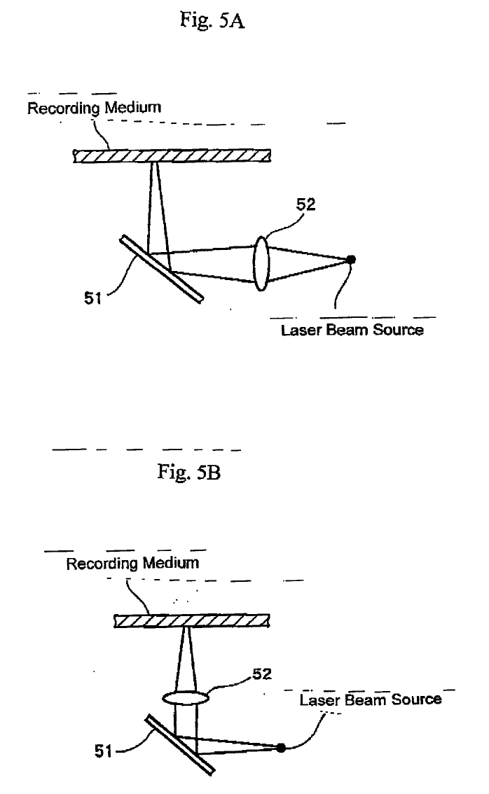

As illustrated in FIG. 2, the slider 2 and the back yoke 3 are respectively provided with passage-holes 5 and 6 through which the laser beam passes. The laser beam emitted under the back yoke 3 travels toward the slider 2 by way of a reflecting mirror (or a prism) 51, a condensing lens 52, etc. (see FIG. 5A or FIG. 5B) and through the passage-hole 6. After passing through the passage-hole 5 of the slider 2, the laser beam is shed onto the recording medium (FD or high density FD) disposed on the slider 2. The passage-holes 5 and 6 are formed through the slider 2 and the back yoke 3, respectively, by molding or machining while the slider 2 and the back yoke 3 are separate before being put together into the magnetic head 1. Since there are two different magnetic cores selectively operated depending on the recording capacity of the recording medium (FD and high density FD), the passage-hole 5 for the laser beam, which is formed through the slider 2, is located halfway between the magnetic core 11 and the magnetic core 12.

Since the laser beam is focussed by the condensing lens on the recording medium, the diameter of the laser beam passing through the passage-hole 6 of the back yoke 3 is different from the diameter of the laser beam passing through the passage-hole 5 of the slider 2. Therefore, the size required for the passage-hole 5 is different from the size required for the passage-hole 6. Namely, the diameter of the passage-hole 5 of the slider 2 positioned closer to the recording medium on which the laser beam is focussed is smaller than the diameter of the passage-hole 6 of the back yoke 3.

As mentioned above, the passage-hole 5 of the slider 2 and the passage-hole 6 of the back yoke 3 are separately formed to have minimal dimensions required, respectively. More specifically, the diameter of the passage-hole 6 can be set to be as small as about 0.7 mm, and the diameter of the passage-hole 5 as small as about 0.5 mm. This makes it possible to maintain a high rigidity in the slider 2, and reduce amount of fine dust particles falling through the passage-hole 5 as well.

FIG. 3 is a sectional view along the line E-E of FIG. 2.

As illustrated in the figure, the passage-hole 5 of the slider 2 and the passage-hole 6 of the back yoke 3 are respectively formed to have the diameters required for permitting the laser beam to pass through. The diameter of the passage-hole 5 formed through the slider 2 is smaller than the diameter of the passage-hole 6 formed through the back yoke 3. Further, the passage-hole 5 is arranged to be concentric with the passage-hole 6.

As described above, according to the optical servo magnetic head of the present invention, a separate type magnetic head composed of the slider and the back yoke enables the respective passage-holes to be formed separately through the slider and the back yoke by molding or machining. Therefore, each of the passage-holes can be formed to have a minimal size required for permitting the condensed laser beam to pass through. This makes it possible to reduce the size of the passage-hole in the slider almost to the spot size of the laser beam focussed on the recording medium. Thus, the lowering of the rigidity in the slider due to the presence of the passage-hole can be reduced, thereby remarkably suppressing the deformation of the sliding surface of the slider that slides on the recording medium with respect to the pressure applied when the magnetic head is assembled. Further, since the fine dust particles that are generated due to the sliding between the recording medium and the sliding surface are allowed to fall through the passage-holes in a reduced amount, the amount of the fine dust particles getting on the reflecting mirror, the prism or the like can be reduced to that extent. Therefore, a servo error due to the lowered illuminance of the laser beam can be decreased.

What is claimed is:

1. An optical servo magnetic head comprising:
a slider which slides on a magnetic recording medium;
magnetic cores which fit in respective openings formed in the slider, are sealed up therein and have respective gaps different from each other to enable the magnetic head to work both for a standard recording density floppy disk drive and a high recording density floppy disk drive;
a back yoke which forms closed magnetic circuits in association with the magnetic cores and holds the slider; and
a track servomechanism which works using a laser beam,
characterized in that a laser beam passage-hole is formed through the slider and the back yoke, respectively.

2. The optical servo magnetic head according to claim 1, wherein the laser beam passage-hole is dimensioned in such a manner as to be smaller at the slider side than at the back yoke side.
